(19) United States
(12) Patent Application Publication
(10) Pub. No.: US 2016/0310914 A1
(43) Pub. Date: Oct. 27, 2016

(54) AERATOR

(71) Applicant: Huei-Wern TSUEI, Taipei City (TW)

(72) Inventor: Huei-Wern TSUEI, Taipei City (TW)

(21) Appl. No.: 14/877,946

(22) Filed: Oct. 8, 2015

(30) Foreign Application Priority Data
Apr. 21, 2015 (TW) 104206068

(51) Int. Cl. B01F 3/04; B01F 15/00; B01F 7/00; B01F 15/06; A01K 63/04; B01F 7/22

(52) U.S. Cl. CPC B01F 3/04539; A01K 63/042; B01F 7/22; B01F 7/00733; B01F 15/065; B01F 15/00974; B01F 15/00779; B01F 2003/04574; B01F 2003/04645; B01F 2015/061; B01F 2015/062

(57) ABSTRACT

An aerator for injecting air into water includes a hollow tube having an inlet end and an outlet end, a hollow dish-shaped element including an upper conical portion and a lower conical portion, blades and a rotating element. The upper conical portion is connected the outlet end. The lower conical portion is located under the upper conical portion. The lower conical portion is spaced from the upper conical portion by a first distance. Each of the blades is connected to the upper conical portion and the lower conical portion, and the blades are arranged in a spiral shape. The rotating element rotates the hollow tube, the hollow dish-shaped element and the blades. The blades strike the water to suck the air through an air intake hole of the inlet end into the hollow dish-shaped element, thereby injecting the air into the water under negative pressure.

### RELATED APPLICATIONS

This application claims priority to Taiwan Application Serial Number 104206068, filed Apr. 21, 2015, which is herein incorporated by reference.

### BACKGROUND

1. Technical Field

The present disclosure relates to an aerator. More particularly, the present disclosure relates to an aerator for increasing mixing efficiency and promoting water circulation.

2. Description of Related Art

In general, an aerator for fish farms is used to suck air by using blades to strike water, thereby injecting the air into the water. However, the amount of oxygen produced by a conventional aerator is quite limited. For example, a conventional paddlewheel aerator is only operated on the local surface area of water. The conventional paddlewheel aerator has a limited aeration range, and cannot achieve sufficient water circulation in the deep eater.

In addition, a conventional jet aerator injects gas, typically air, into a liquid stream. Although the conventional jet aerator can increase more oxygen in water than that of the conventional paddlewheel aerator, it is still not enough to achieve required circulation.

Another conventional aerator, which mainly consists of a motor, a drive shaft, plural blades and a tub, is fabricated within the relevant industry. The motor is immersed in water and drives the blades to rotate at a high speed by the drive shaft, thereby flowing the water along a fixed direction. The blades strike the water to suck air through the air intake hole into the tube, and then air can be injected into water under negative pressure, and thus the amount of oxygen in water will be increased. However, when the motor is immersed in water, the motor housing is not only susceptible to corrosion, but also substantially has increasing risk of electrical shock due to current leakage. Therefore, this kind of conventional aerator is not safe for users and still cannot achieve sufficient water circulation.

A conventional venturi aerator is provided to enhance water flow This conventional venturi aerator is a fluid control device which reduces a cross-sectional area of a flow path by a venturi throat so as to increase the flow rate of water. However, such kind of venturi aerator just injects water in one single direction, and air has a relatively small contact surface with water even if it has plural venturi tubes. Hence, the conventional venturi aerator still cannot achieve required circulation, Therefore, it is desirable to develop an aerator with a higher efficiency of mixing air and water, and sufficient water circulation.

### SUMMARY

According to one aspect of the present disclosure, an aerator for injecting air into water includes a hollow tube, a hollow dish-shaped element, plural blades and a rotating element. The hollow tube includes an inlet end and an outlet end. The inlet end has an air intake hole. The hollow dish-shaped element is connected to the hollow tube. The hollow dish-shaped element includes an upper conical portion and a lower conical portion. The upper conical portion is connected to the outlet end. The lower conical portion is located under the upper conical portion. The lower conical portion is spaced from the upper conical portion by a first distance. The blades are located between the lower conical portion and the upper conical portion. Each of the blades is connected to the upper conical portion and the lower conical portion, and the blades are arranged in a spiral shape. The rotating element rotates the hollow tube, the hollow dish-shaped element and the blades. The blades strike the water to suck air through the air intake hole into the hollow dish-shaped element so as to inject the air into water under negative pressure.

According to another aspect of the present disclosure, an aerator for injecting air into water includes a hollow tube, plural vanes, a hollow dish-shaped element, plural blades and a rotating element. The hollow tube includes an inlet end and an outlet end. The inlet end has an air intake hole and a top-wide-bottom-narrow shape. The vanes are connected to the inlet end. The hollow dish-shaped element is connected to the hollow tube. The hollow dish-shaped element includes an upper conical portion and a lower conical portion. The upper conical portion is connected the outlet end. The lower conical portion is located under the upper conical portion. The lower conical portion is spaced from the upper conical portion by a first distance.

The blades are located between the lower conical portion and the upper conical portion. Each of the blades is connected to the upper conical portion and the lower conical portion, and the blades are arranged in a spiral shape. The rotating element rotates the hollow tube, the hollow dish-shaped element and the blades. The blades strike the water to suck air through the air intake hole into the hollow dish-shaped element so as to inject air into water under negative pressure.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram showing an aerator according to one embodiment of the present disclosure;

FIG. 2 is a schematic diagram showing a hollow dish-shaped element, blades and a circular hollow frame of the aerator in FIG. 1;

FIG. 3 is a cross-sectional view showing a hollow tube, an upper conical portion and the blades of the aerator in FIG. 1;

FIG. 4A is a schematic diagram showing vanes of n aerator according to another embodiment of the present disclosure; and

FIG. 4B is a cross-sectional view showing an inlet end, an air intake hole, vanes and supporting columns of the aerator in FIG. 4A.

### DETAILED DESCRIPTION

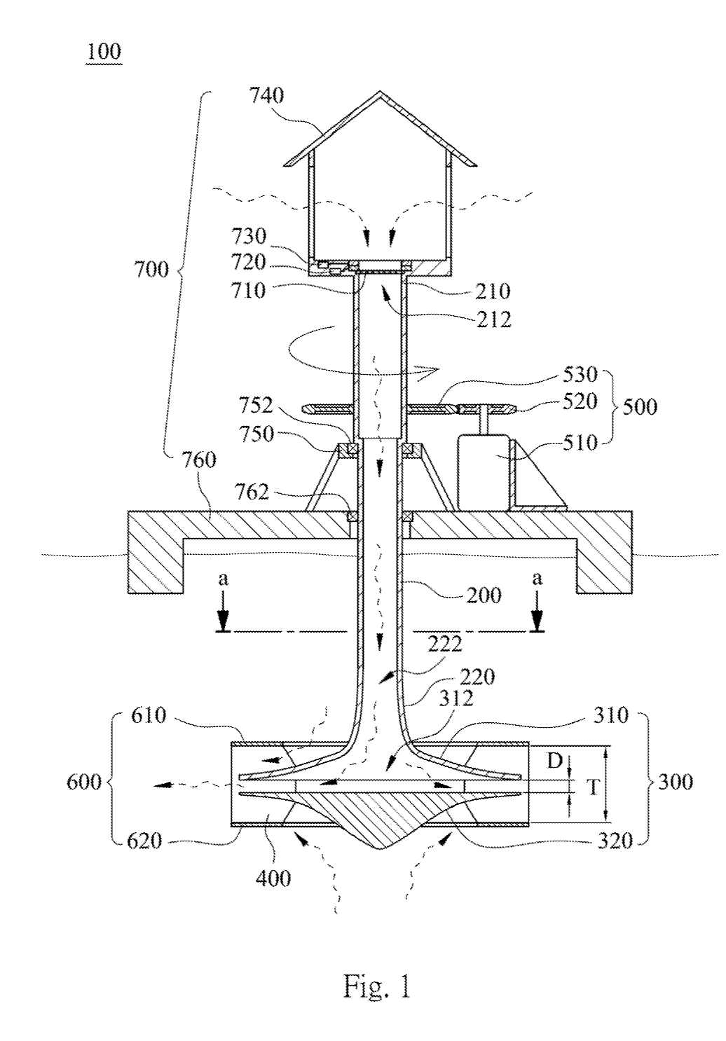

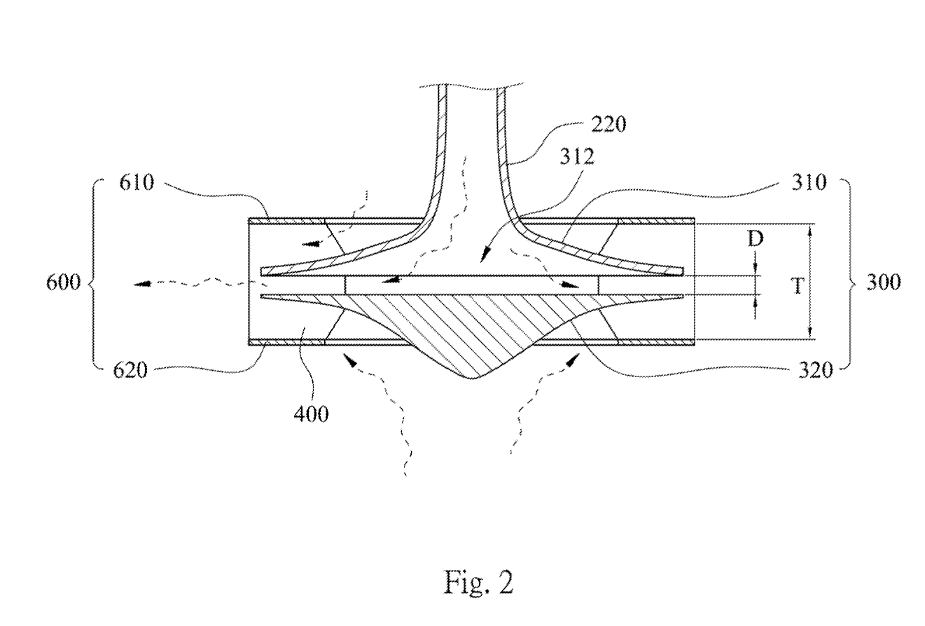

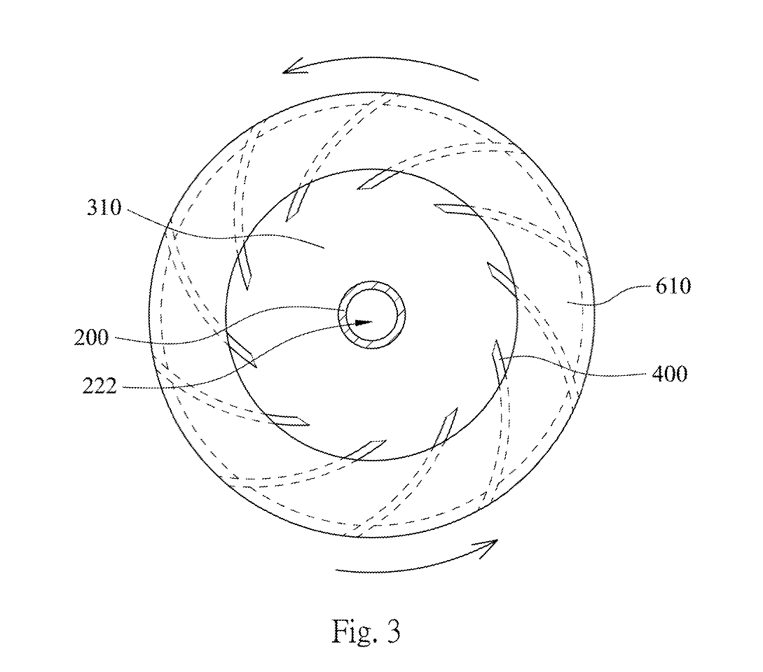

FIG. 1 is a schematic diagram showing an aerator 100 according to one embodiment of the present disclosure; FIG. 2 is a schematic diagram showing a hollow dish-shaped element 300, blades 400 and a circular hollow frame 600 of the aerator 100 in FIG. 1; and FIG. 3 is a cross-sectional view showing a hollow tube 200, an upper conical portion 310 and the blades 400 of the aerator 100 in FIG. 1. In FIG. 1, the aerator 100 includes the hollow tube 200, the hollow dish-shaped element 300, the blades 400, a rotating element 500, the circular hollow frame 600 and an upper component group 700.

The hollow tube 200 includes an inlet end 210 and an outlet end 220 The inlet end 210 has an air intake hole 212. The outlet end 220 has an outlet hole 222. The air intake hole 212 is connected to the outlet hole 222. When the aerator 100 is operated in water, the inlet end 210 is located above the water surface, and the outlet end 220 is located in water, so that air can be sucked from the inlet end 210 into the outlet end 220 and then injected into water. In addition, the hollow tube 200 is made from a rigid material, and has an elongated cylindrical shape, and thus its length is much greater than its diameter.

The hollow dish-shaped element 300 includes an upper conical portion 310 and a lower conical portion 320. The lower conical portion 320 is located under the upper conical portion 310. The upper conical portion 310 is integrally connected to the outlet end 220. The upper conical portion 310 has a vent hole 312, and the outlet hole 222 connects the vent hole 312 to the air intake hole 212. The lower conical portion 320 is spaced from the upper conical portion 310 by a first distance D. The upper conical portion 310 connected to the hollow tube 200 has a top-narrow-bottom-wide shape, (i.e. horn-like shape). The lower conical portion 320 has an inverted conical shape. The upper conical portion 310 is corresponding to the lower conical portion 320, and their facing surfaces has the same area, so that the hollow dish-shaped element 300 composed of the upper conical portion 310 and the lower conical portion 320 has a disc shape. Moreover, the first distance D depends on a rotational speed of the hollow dish-shaped element 300. If the rotational speed of the hollow dish-shaped element 300 is increased, the first distance D can be increased to drive more air into N, water, thus increasing the efficiency of mixing air and water. The larger the perimeters of the upper conical portion 310 and the lower conical portion 320 are, the higher efficiency of mixing air and water is. In other words, under the condition of the same volume, the larger the inclined angle between a center of the upper conical portion 310 and its peripheral edge is, the larger the perimeter of the upper conical portion 310 is, and the higher efficiency of mixing air and water is. On the other hand, the larger the inclined angle is, the higher the manufacturing cost in the manufacture of the hollow dish-shaped element 300 is. Therefore, the perimeters of the upper conical portion 310 and the lower conical portion 320 have to be carefully designed under the trade-off between the mixing efficiency and the manufacturing cost.

The blades 400 are located between the upper conical portion 310 and the lower conical portion 320. Each of the blades 400 is connected to the upper conical portion 310 and the lower conical portion 320. Each of the blades 400 is outwardly extended from the hollow dish-shaped element 300. In other words, each of the blades 400 protrudes from the outer edge of the hollow dish-shaped element 300 and extends outward. Hence, the outer end of each of the blades 400 is located outside the hollow dish-shaped element 300. The blades 400 are perpendicularly engaged between the upper conical portion 310 and the lower conical portion 320, such that an extending direction of each of the blades 400 is parallel to an extending direction of the hollow tube 200. Each of the blades has a rectangular shape, a hexagonal shape or a polygonal shape. In this embodiment, each of the blades has a hexagonal shape and is a flat plate. The number of the blades 400 connected to the hollow dish-shaped element 300 is ten, for example. The blades 400 are engaged with the hollow dish-shaped element 300 and spaced at an equal distance. Since the angle between each of the blades 400 and a tangent of the edge of the dish-shaped element 300 is smaller than 90 degrees, the blades 400 are arranged in a spiral shape. When the blades 400 are rotated by the hollow dish-shaped element 300, the aerator 100 can drain water from the outside of the outlet end 220 of the hollow tube 200 along the arc-shaped surface of the upper conical portion 310, and then water is drained to the outside of the blades 400. Moreover, the blades 400 having different shapes can be disposed on the hollow dish-shaped element 300, such as an arc shape or other shapes. No matter what shape of the blades 400 is used, the blades 400 rotated by the hollow dish-shaped element 300 can quickly push the water away from the blades 400, so that the water is drained from the outside of the outlet end 220 of the hollow tube 200 along the arc-shaped surface of the upper conical portion 310, and then water is drained to the outside of the blades 400. At the same time the aerator 100 can drain water from the bottom of the lower conical portion 320 along the conical tip and the arc-shaped surface of the lower conical portion 320, and then water is drained to the outside of the blades 400. In other words, water around the hollow dish-shaped element 300 is sequentially drained to the outside of the blades 400 so as to achieve sufficient water circulation.

The rotating element 500 includes a motor 510, a linking gear 520 and a tube gear 530. The linking gear 520 is coaxially and pivotally connected to the motor 510, The tube gear 530 is arranged around an outer wall of the hollow tube 200, and the tube gear 530 is engaged with the linking gear 520 for rotating the hollow tube 200. Due to the coaxial and pivotal connection between the motor 510 and the linking gear 520, the linking gear 520 is rotated by the motor 510 in the same direction at the same speed. The tube gear 530 is rotated by the linking gear 520 in the reverse direction at the same speed. Hence, the hollow tube 200 can be rotated by the rotating element 500 to rotate the hollow dish-shaped element 300 and the blades 400. If the motor 510 is rotated clockwise, the linking gear 520 is rotated clockwise, and the tube gear 530 and the hollow tube 200 are rotated counterclockwise. On the contrary, if the motor 510 is rotated counterclockwise, the linking gear 520 is rotated counterclockwise, and the tube gear 530 and the hollow tube 200 are rotated clockwise. The rotational direction of the motor 510 should be based on the arrangement of the blades 400 to drain water from the inside to the outside of the hollow dish-shaped element 300. The motor 510 of the rotating element 500 stably rotates the hollow tube 200, the hollow dish-shaped element 300 and the blades 400 together. The blades 400 strike water to suck air through the air intake hole 212 into the hollow dish-shaped element 300 so as to inject air into water under negative pressure. Therefore, the aerator 100 of the present disclosure uses the venturi tube to inject air into water by Bernoulli's principle. It not only can greatly increase the efficiency of mixing air and water, but also achieve more sufficient water circulation than conventional aerators. The mixing efficiency of the aerator 100 is more effective than conventional aerators, and the water circulation is more efficient than the conventional one.

The circular hollow frame 600 has two circular hollow plates 610 and 620. The two circular hollow plates 610 and 620 are respectively connected to two opposite ends of each of the blades 400. The two circular hollow plates 610 and 620 are separated by a second distance T, and the second distance T is corresponding to a height of each of the blades 400. Each of the circular hollow plates 610 and 620 has an annular shape with the same size. Each of the circular hollow plates 610 and 620 has a center perforation. The conical tip of the lower conical portion 320 is protruded through the center perforation of the circular hollow plate 620. This center perforation of the circular hollow plate 620 can permit water to flow along the arc-shaped surface of the lower conical portion 320, and then water can be sequentially drained to the outside of the blades 400. Thus, the circular hollow frame 600 not only can fix the blades 400 and increase the stability of the rotational blades 400, but also can smoothly drain water by the center perforation so as to achieve sufficient water circulation.

The upper component group 700 includes an air filter element 710, a heating element 720, a cooling element 730, a rain cover 740, a circular fixed frame 750 and a raft 760. The air filter element 710 is disposed on the inlet end 210 of the hollow tube 200, and can completely close the inlet end 210 of the hollow tube 200 The air filter element 710 can be used for filtering air, so that the air filter element 710 cleans air before air is injected into water and improves water quality. The heating element 720 is disposed on the inlet end 210 of the hollow tube 200 for heating air. The heating element 720 may increase the temperature of air sucked from the air intake hole 212 in cold weather. The cooling element 730 is disposed on the inlet end for cooling the air. The cooling element 730 may decrease the temperature of air sucked from the air intake hole 212 in hot weather. The heating element 720 and the cooling element 730 can be disposed inside any part of the hollow tube 200 to change the temperature of air sucked from the air intake hole 212. The rain cover 740 is located above and covers the air filter element 710, the heating element 720 and the cooling element 730 to avoid being damaged due to continuous exposure to rain and sun. The circular fixed frame 750 is configured to block and hold the hollow tube 200. The circular fixed frame 750 has a bearing 752 connected to the hollow tube 200 for stably rotating the hollow tube 200. The raft 760 is used to sustain the hollow tube 200, the air filter element 710, the heating element 720, the cooling element 730, the rain cover 740 and the circular fixed frame 750. The raft 760 also has a bearing 762 connected to the hollow tube 200 for balancedly rotating the hollow tube 200.

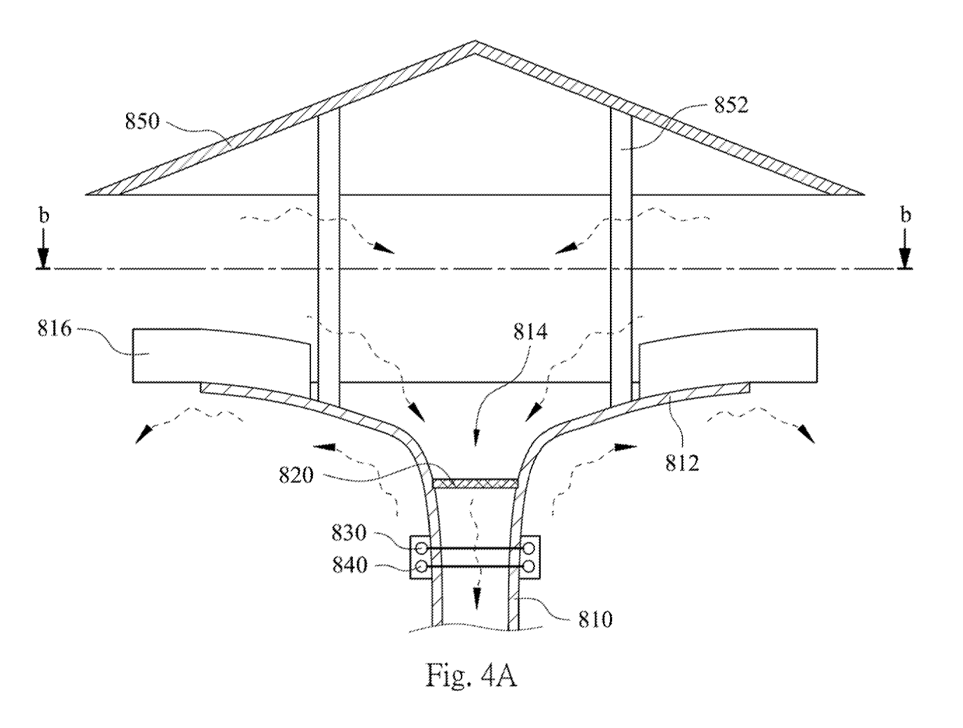

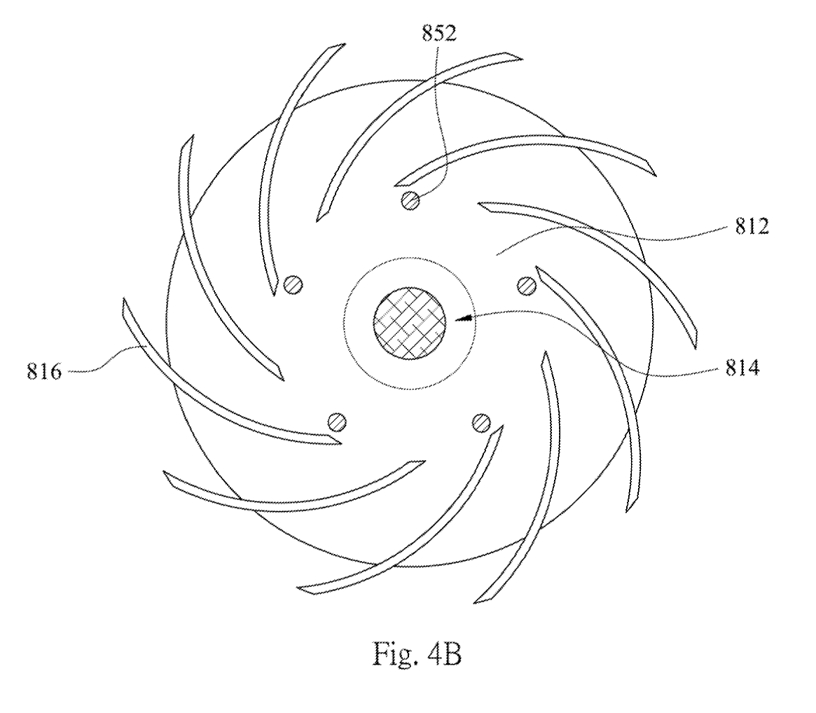

FIG. 4A is a schematic diagram showing vanes 816 of an aerator according to another embodiment of the present disclosure; and FIG. 4B is a cross-sectional view showing an inlet end 812, an air intake hole 814, the vanes 816 and supporting columns 852 of the aerator in FIG. 4A. In FIG. 4A, the aerator includes a hollow tube 810, an air filter element 820, a heating element 830, a cooling element 840 and a rain cover 850.

The hollow tube 810 has an inlet end 812, and the inlet end 812 has an air intake hole 814. The vanes 816 are disposed on the inlet end 812. The vanes 816 are all fixed on the top surface of the inlet end 812. The inlet end 812 has a top-wide-bottom-narrow shape, (i.e. horn-like shape or inverted conical shape). Hence, a hole diameter of the air intake hole 814 is much larger than a hole diameter' of the air intake hole 212, so that this structure can suck more amount of air into the air intake hole 814 for increasing the efficiency of mixing air and water. In addition, the vanes 816 are arranged in a spiral shape. Each of the vanes can be an arc shape or a long plate shape. In this embodiment, each of the vanes is an arc shape. The vanes 816 can be used to propel air above water for sucking the fresh air from the top of the air intake hole 814 into the hollow tube 810. The vanes 816 can disperse the air containing carbon dioxide or other impurities from the water. In addition, the air filter element 820, the heating element 830 and the cooling element 840 are disposed on the inlet end 812 of the hollow tube 810. The air filter element 820 is used for filtering air. The heating element 830 and the cooling element 840 can be disposed inside any part of the hollow tube 810 to change the temperature of air sucked from the air intake hole 814. The rain cover 850 has a horn-like shape. The inlet end 812 and the rain cover 850 both are located above the heating element 830 and the cooling element 840 for covering them to avoid being damaged due to continuous exposure to rain and sun. The rain cover 850 is located above and covers the air filter element 820 for preventing the air filter element 820 from being damaged. Supporting columns 852 are utilized to firmly connect the rain cover 850 and the inlet end 812, so that the rain cover 850 can be synchronously rotated with the hollow tube 810.

According to the aforementioned embodiments and examples, the advantages of the present disclosure are described as follows.

The aerator of the present disclosure connects the special hollow dish-shaped element to the blades for increasing the perimeters of the hollow dish -shaped element so as to improve the mixing efficiency by increasing the contact area between air and water.

The aerator of the present disclosure can use the circular hollow frame to fix the blades and increase the stability of the rotational blades. Moreover, the water can be smoothly drained through the center perforation so as to achieve sufficient water circulation.

The aerator of the present disclosure can utilize the vanes disposed on the inlet end with the larger hole diameter of the air intake hole to suck more air for increasing the efficiency of mixing air and water. In addition, the vanes can be used to propel air above water for sucking fresh air into the hollow tube and disperse the air containing carbon dioxide or other impurities from the water.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An aerator for injecting air into water, the aerator comprising:
a hollow tube comprising an inlet, end and an outlet end, wherein the inlet:
end has an air intake hole;
a hollow dish-shaped element connected to the hollow tube, the hollow dish-shaped element comprising:
an upper conical portion connected to the outlet end; and
a lower conical portion located under the upper conical portion, wherein the lower conical portion is spaced from the upper conical portion by a first distance;
a plurality of blades located between the lower conical portion and the upper conical portion, wherein each of the blades is connected to the upper conical portion and the lower conical portion, and the blades are arranged in a spiral shape; and
a rotating element rotating the hollow tube together with the hollow dish-shaped element and the blades, wherein the blades strike the water to suck air through the air intake hole into the hollow dish-shaped element so as to inject the air into the water under negative pressure.

2. The aerator of claim 1, wherein each of the blades is outwardly extended from the hollow dish-shaped element, and an extending direction of each of the blades is parallel to an extending direction of the hollow tube.

3. The aerator of claim 1, wherein the upper conical portion has a vent hole, the outlet end has an outlet hole, and the outlet hole connects the vent hole to the air intake hole.

4. The aerator of claim 1, further comprising:
a circular hollow frame having two circular hollow plates, wherein the two circular hollow plates are respectively connected to two opposite ends of each of the blades and are separated by a second distance, and the second distance is corresponding to a height of each of the blades.

5. The aerator of claim 4, wherein the hollow tube has an elongated cylindrical shape, and the lower conical portion has a conical shape, and a top end of the lower conical portion is protruded through a center opening of one of the circular hollow plates, and each of the blades has a rectangular shape or a hexagonal shape, and each of the circular hollow plates has an annular shape.

6. The aerator of claim 1, wherein the rotating element comprises a motor, a linking gear and a tube gear, and the linking gear is coaxially and pivotally connected to the motor, and the tube gear is arranged around an outer wall of the hollow tube, and the tube gear is engaged with the linking gear for rotating the hollow tube.

7. The aerator of claim 1, further comprising:
an air filter element disposed on the inlet end for filtering the air;
a heating element disposed on the inlet end for heating the air;
a cooling element disposed on the inlet end for cooling the air; and
a rain cover located above the air filter element, the heating element and the cooling element for covering the air filter element, the heating element and the cooling element.

8. An aerator for injecting air into water, the aerator comprising:
a hollow tube comprising an inlet end and an outlet end, wherein the inlet end has an air intake hole and a top-wide-bottom-narrow shape;
a plurality of vanes connected to the inlet end;
a hollow dish-shaped element connected to the hollow tube, the hollow dish-shaped element comprising:
an upper conical portion connected to the outlet end; and
a lower conical portion located under the upper conical portion, wherein the lower conical portion is spaced from the upper conical portion by a first distance;
a plurality of blades located between the lower conical portion and the upper conical portion, wherein each of the blades is connected to the upper conical portion and the lower conical portion, and the blades are arranged in a spiral shape; and
a rotating element rotating the hollow tube, the hollow dish-shaped element and the blades, wherein the blades strike the water to suck the air through the air intake hole into the hollow dish-shaped element so as to inject the air into water under negative pressure.

9. The aerator of claim 8, wherein the vanes are arranged in a spiral shape, each of the vanes has an arc shape, and the inlet end has a horn-like shape or a conical shape.

10. The aerator of claim 8, further comprising:
a circular hollow frame having two circular hollow plates, wherein the two circular hollow plates are respectively connected to two opposite ends of each of the blades, and the two circular hollow plates are separated by a second distance, and the second distance is corresponding to a height of each of the blades, and each of the circular hollow plates has an annular shape.

11. The aerator of claim 10, wherein the hollow tube has an elongated cylindrical shape, and the lower conical portion has a conical shape, and a top end of the lower conical portion is protruded through a center opening of one of the circular hollow plates, and each of the blades has a rectangular shape or a hexagonal shape.

12. The aerator of claim 8. wherein each of the blades is outwardly extended from the hollow dish-shaped element, and an extending direction of each of the blades is parallel to an extending direction of the hollow tube.

13. The aerator of claim 8, wherein the upper conical portion has a vent hole, the outlet end has an outlet hole, and the outlet hole connects the vent hole to the air intake hole.

14. The aerator of claim 8, wherein the rotating element comprises a motor, a linking gear and a tube gear, and the linking gear is coaxially and pivotally connected to the motor, and the tube gear is arranged around an outer wall of the hollow tube, and the tube gear is engaged with the linking gear for rotating the hollow tube.

15. The aerator of claim 8, further comprising:
an air filter element disposed on the inlet end for filtering the air;
a heating element disposed on the inlet end for heating the air;
a cooling element disposed on the inlet end for cooling the air; and
a rain cover located above the air filter element, the heating element and the cooling element for covering the air filter element, the heating element and the cooling element.
